(19) United States
(12) Patent Application Publication
(10) Pub. No.: US 2014/0177810 A1
(43) Pub. Date: Jun. 26, 2014

(54) SYSTEM AND METHODS FOR X-RAY TUBE AGING DETERMINATION AND COMPENSATION

(71) Applicant: GE GLOBAL RESEARCH, Schenectady, NY (US)

(72) Inventors: Hewei Gao, Niskayuna, NY (US); Floribertus P. Heukensfeldt Jansen, Niskayuna, NY (US); Uwe Wiedmann, Niskayuna, NY (US); Bruno De Man, Niskayuna, NY (US)

(73) Assignee: GE Global Research, Schenectady, NY (US)

(21) Appl. No.: 13/724,509

(22) Filed: Dec. 21, 2012

(51) Int. Cl. G01T 1/00

(52) U.S. Cl. CPC G01T 1/00
USPC 378/207

(57) ABSTRACT

Exemplary embodiments are directed to a system and method for estimating and compensating for anode target filtration in an X-ray tube. Certain embodiments record changes in the photon flux over the life of the tube. By comparing the flux values, filtration resulting from a roughened target surface and target deposition on the tube window may be inferred. A plurality of systems and methods for comparing flux values are provided and the relative merits and complementary effects of each discussed.

### BACKGROUND

X-ray tubes may be used to generate X-rays in a variety of applications. X-ray computed tomography imaging, for example, also referred to as computed tomography (CT-scan, CT) or computed axial tomography (CAT scan), employs computer-processed X-rays to generate tomographic images of an object of interest. The system successively emits and detects photons in the X-ray frequency range, directed to an object, so as to generate a plurality of consecutive cross-sectional tomographic images of the object's contents. These cross-sectional tomographic images may then be used to generate a three-dimensional image of the inside of the object. The three-dimensional image may be used for diagnostic and therapeutic purposes in various medical disciplines, but may also be used in a wide variety of other contexts, such as baggage inspection. X-ray tubes may be used for other applications than computed tomography, such as crystallography.

X-ray tube operation and behavior may change as the X-ray tube ages. For example, the target anode material within the tube may begin to crack and/or be deposited upon a window of the X-ray tube, adversely affecting the quality of the emitted X-rays. Accordingly, there exists a need for monitoring and/or compensating for such behavior to prolong the functional life of the X-ray tube.

### SUMMARY

Certain embodiments contemplate a method for estimating anode filtration in an X-ray tube, comprising: applying a current and a voltage to the X-ray tube; emitting a plurality of photons from the X-ray tube; determining a first flux at which at least some of the plurality of photons are detected at a detector; comparing the first flux with a second stored flux value, the second stored flux value based on a previous application of the current and the voltage to the X-ray tube; and determining a degree of anode filtration based on the comparison of the first flux with the second stored flux value.

In some embodiments, the previous application of the current and the voltage to the X-ray tube occurred upon the first activation of the X-ray tube. In some embodiments, the anode filtration comprises tungsten. In some embodiments, the method further comprises estimating the life of the X-ray tube based upon the degree of anode filtration. In some embodiments, determining a degree of anode filtration comprises supplying the comparison to a function mapping the comparison to a degree of anode filtration.

Certain embodiments contemplate a method for estimating anode filtration in an X-ray tube, comprising: applying a current and a voltage to the X-ray tube; emitting a plurality of photons from the X-ray tube; determining a first flux at which at least some of the plurality of photons are detected at a first row of a detector; determining a second flux at which at least some of the plurality of photons are detected at a second row of the detector; determining a relative change value between the first and second flux; comparing the relative change value with a stored relative change value, the stored relative change value based on a previous application of substantially the same current and substantially the same voltage to the X-ray tube; and determining a degree of anode filtration based on the comparison of the relative change value and the stored relative change value.

In some embodiments, the previous application of the current and the voltage to the X-ray tube occurred upon the first activation of the X-ray tube. In some embodiments, the anode filtration comprises tungsten. In some embodiments, the method further comprises estimating the remaining life of the X-ray tube based upon the degree of anode filtration. In some embodiments, determining a degree of anode filtration comprises supplying the comparison to a function mapping the comparison to a degree of anode filtration.

Certain embodiments contemplate a method for estimating anode filtration in an X-ray tube, comprising: applying a first voltage to the X-ray tube; emitting a first plurality of photons from the X-ray tube; determining a first flux at which at least some of the first plurality of photons are detected at a detector; applying a second voltage to the X-ray tube; emitting a second plurality of photons from the X-ray tube; determining a second flux at which at least some of the second plurality of photons are detected at a detector; determining a first relation value between the first and second flux; comparing the first relation value with a second stored relation value, the second stored relation value based on a previous application of substantially the same first voltage and substantially the same second voltage to the X-ray tube; and determining a degree of anode filtration based on the comparison of the first relation value and the second stored relation value.

In some embodiments, the first relation value is a ratio of the first flux and the second flux and the stored relation value is a ratio of a first flux and a second flux. In some embodiments, the previous application of substantially the same first voltage and substantially the same second voltage to the X-ray tube occurred upon the first activation of the X-ray tube. In some embodiments, the X-ray tube comprises tungsten deposition on an X-ray window. In some embodiments, the method further comprises estimating the remaining life of the X-ray tube based upon the degree of anode filtration. In some embodiments, determining a degree of anode filtration comprises supplying the comparison to a function mapping the comparison to a degree of anode filtration.

Certain embodiments contemplate a method for estimating anode filtration in an X-ray tube, comprising: applying a first amount of spectral filtering to at least a portion of the X-ray tube using a spectral filter; emitting a first plurality of photons from the X-ray tube with the first amount of spectral filtering; determining a first flux at which at least some of the first plurality of photons are detected at a detector; emitting a second plurality of photons from the X-ray tube with a second amount of spectral filtering, the second amount of spectral filtering different from the first amount of spectral filtering; determining a second flux at which at least some of the second plurality of photons are detected at a detector; determining a first relation value between the first and second flux; comparing the first relation value with a second stored relation value, the second stored relation value based on a previous photon emission from the X-ray tube applying the first amount of spectral filtering and a photon emission from the X-ray tube applying the second amount of spectral filtering; and determining a degree of anode filtration based on the comparison of the first relation value and the second stored relation value.

In some embodiments, the first relation value is a ratio of the first flux and the second flux and the stored relation value is a ratio of a first flux and a second flux. In some embodiments, the previous photon emission from the X-ray tube applying the first amount of spectral filtering and the previous photon emission from the X-ray tube applying the second amount of spectral filtering occurred upon the first activation of the X-ray tube. In some embodiments, the anode filtration comprises tungsten. In some embodiments, the method further comprises estimating the life of the X-ray tube based upon the degree of anode filtration. In some embodiments, determining a degree of anode filtration comprises supplying the comparison to a function mapping the comparison to a degree of anode filtration.

Any combination or permutation of embodiments is envisaged. Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1A is a pictorial view of a computed tomography (CT) imaging system in connection with which various embodiments may be implemented. FIG. 1B is a block schematic diagram of the CT imaging system of FIG. 1A.

FIG. 2 is a schematic block diagram of an X-ray imaging system in connection with which various embodiments may be implemented.

FIG. 3 is an exemplary computing device which may be programmed and/or configured to operate, for example, the system of FIGS. 1A, B and may also be used to implement certain processes described in relation to various embodiments of the present disclosure.

FIG. 4 is an exemplary figure of a rotating anode X-ray tube as may be used in certain embodiments.

FIG. 5 is a cross-sectional view of the surface of an anode target.

FIG. 6 is a plot of the change of the relative flux from the X-ray tube as target filtration increases.

FIG. 7A is a plot of the effect of target filtration per detector row as a consequence of a roughened anode surface.

FIG. 7B is a plot of the effect of target filtration per detector row as a consequence of window deposition.

FIG. 8 is a flow chart depicting aspects of an “Absolute Flux Change” method for determining a degree of target filtration.

FIG. 9 is a flow chart depicting aspects of a “Row-to-Row Change” method for determining a degree of target filtration.

FIG. 10 is a flow chart depicting aspects of a “Flux Ratio” method for determining a degree of target filtration.

FIG. 11 is a flow chart depicting aspects of an “Spectral Transmission Change” method for determining a degree of target filtration.

### DESCRIPTION OF EXEMPLARY EMBODIMENTS

In exemplary embodiments, systems and methods for estimating and compensating for filtration in an X-ray tube are provided. Certain embodiments record changes in the photon flux over the life of the tube. For example, the system may record the flux on the daily startup routine for the tube and compare the value to a flux measured on the tube's first use. By comparing the flux values, filtration resulting from a roughened target surface and target deposition on the tube window may be inferred. A plurality of methods for comparing flux values are provided and the relative merits and complementary effects of each discussed.

### Computed Tomography Scanner Overview

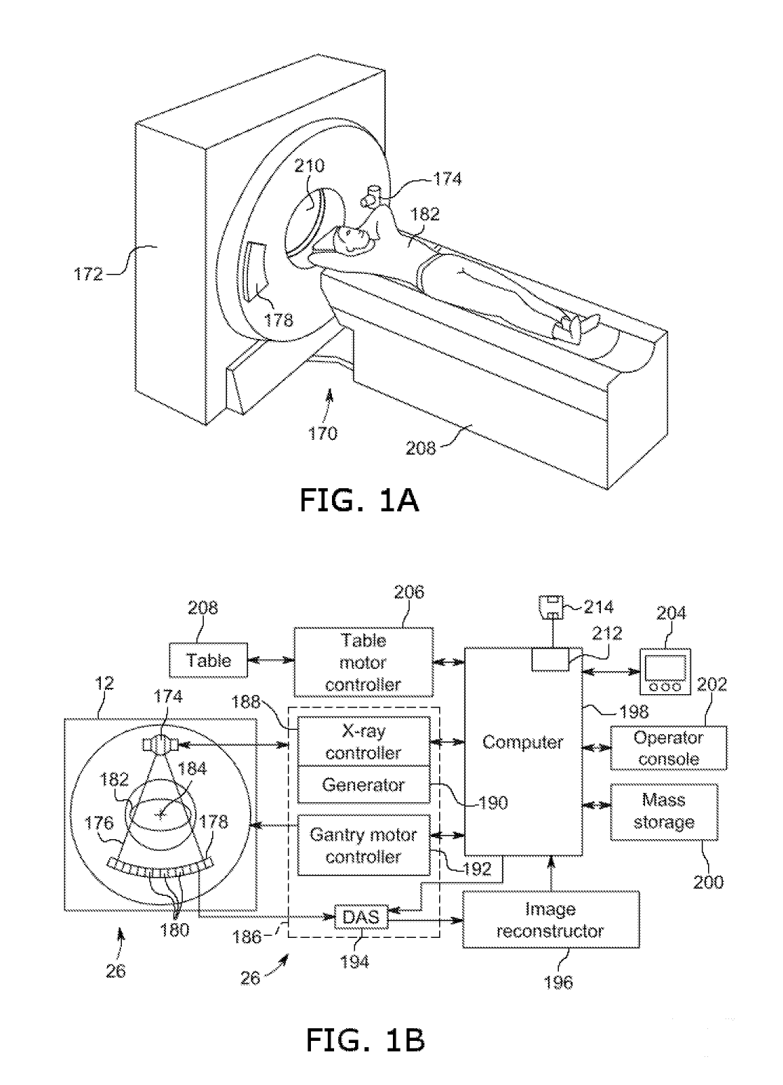

FIG. 1A is a pictorial view of a CT imaging system 170. FIG. 1B is a block schematic diagram of the system 170 illustrated in FIG. 1A. In the exemplary embodiment, the CT imaging system 170 is shown as including a gantry 172 representative of a “third generation” CT imaging system. The gantry 172 has an X-ray source 174 that projects a cone beam 176 of X-rays toward a detector array 178 on the opposite side of gantry 172.

The detector array 178 may be formed by a plurality of detector rows (not shown) including a plurality of detector elements 180 that together sense the projected X-ray beams that pass through an object, such as a medical patient 182 or piece of luggage. Each detector element 180 may produce an electrical signal that represents the intensity of an impinging X-ray radiation beam and hence is indicative of the attenuation of the beam as it passes through object or patient 182. The intensity may correspond to the number of incident photons at the element. An imaging system 170 having a multislice detector 178 may be capable of providing a plurality of images representative of a volume of object 182. Each image of the plurality of images corresponds to a separate “slice” of the volume. The “thickness” or aperture of the slice is dependent upon the height of the detector rows.

During a scan to acquire X-ray projection data, a rotating section within the gantry 172 and the components mounted thereon rotate about a center of rotation 184. FIG. 1B shows only a single row of detector elements 180 (i.e., a detector row). However, the multislice detector array 178 may include a plurality of parallel detector rows of detector elements 180 such that projection data corresponding to cone-beam geometry can be acquired simultaneously during a scan.

Rotation of components within the gantry 172 and the operation of radiation source 174 may be governed by a control mechanism 186. The control mechanism 186 includes an X-ray controller 188 and generator 190 that provides power and timing signals to the X-ray source 174 and a gantry motor controller 192 that controls the rotational speed and position of rotating portion of gantry 172. A data acquisition system (DAS) 194 in the control mechanism 186 samples analog data from detector elements 180 and converts the data to digital signals for subsequent processing. An image reconstructor 196 receives sampled and digitized measurement data from the DAS 194 and performs high-speed image reconstruction. The reconstructed image is applied as an input to a computer 198 that stores the image in a mass storage device 200. Although shown as a separate device, image reconstructor 196 may be special hardware located inside computer 198 or software executing within computer 198.

The computer 198 also receives commands and scanning parameters from an operator via a console 202 that has a keyboard and/or other user input device(s). An associated display system 204 allows the operator to observe the reconstructed image and other data from the computer 198. The operator supplied commands and parameters may be used by the computer 198 to provide control signals and information to the DAS 194, X-ray controller 188, generator 190 and gantry motor controller 192. In addition, the computer 198 operates a table motor controller 206 that controls a motorized table 208 to position the patient 182 in the gantry 172. The table 208 moves portions of the patient 182 through a gantry opening 210.

In one embodiment, the computer 198 includes a device 212, for example, a floppy disk drive, CD-ROM drive, DVD-ROM drive, or a solid state hard drive for reading instructions and/or data from a computer-readable medium 214, such as a floppy disk, CD-ROM, or DVD. It should be understood that other types of suitable computer-readable memory are recognized to exist (e.g., CD-RW and flash memory, to name just two), and that this description is not intended to exclude any of these. In another embodiment, the computer 198 executes instructions stored in firmware (not shown). Generally, a processor in at least one of the DAS 194, reconstructor 196, and computer 198 shown in FIG. 1B may be programmed to execute control commands to perform switching as described in more detail herein. The switching is not limited to practice in the CT system 170 and can be utilized in connection with many other types and variations of imaging systems. In one embodiment, the computer 198 is programmed to perform different functions to switch the switching devices described herein, accordingly, as used herein, the term computer is not limited to just those integrated circuits referred to in the art as computers, but broadly refers to computers, processors, microcontrollers, microcomputers, programmable logic controllers, application specific integrated circuits, and other programmable circuits.

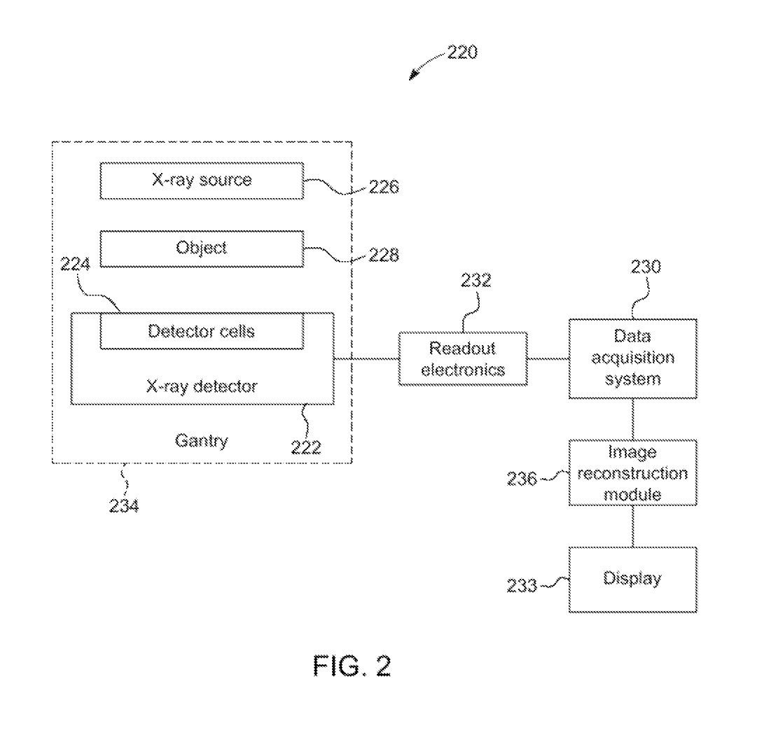

FIG. 2 illustrates an X-ray imaging system 220 in which various embodiments may be implemented. The imaging system 220 generally includes an X-ray detector 222 having an array of detector cells 224 defining a scan area, and an X-ray source 226. Detector cells 224 may be the same as the elements 180 of the CT scanner of FIG. 1B in some embodiments. An object 228, such as a patient, is positioned between the X-ray source 226 and the X-ray detector 222, which may be one or more detectors or detector modules. However, the imaging system 220 may also scan other objects, such as in an industrial inspection application. The imaging system 220 also includes a data acquisition system 230 with readout electronics 232. Although shown separately in FIG. 2, the readout electronics 232 may reside within the X-ray detector 222 or the data acquisition system 230.

In one embodiment, the X-ray detector(s) 222 may be flat-panel detector systems such as an amorphous silicon flat panel detector or other type of digital X-ray image detector, such as a direct conversion detector as known to those skilled in the art. In another embodiment, the X-ray detector(s) 222 may include a scintillator having a screen that is positioned in front of the X-ray detector(s) 222.

It should be noted that the imaging system 220 may be implemented as a non-mobile or mobile imaging system. Moreover, the imaging system 220 may be provided in different configurations. For example, the image data may be generated with the X-ray source 226 positioned at discrete foci along an arc above the object to generate the image information using computed tomosynthesis procedures and processes (or may be in a radiographic configuration). In other embodiments, the X-ray source 226 and the X-ray detector 222 are both mounted at opposite ends of a gantry 234, which may be a C-arm that rotates about the object 228. The rotatable C-arm is a support structure that allows rotating the X-ray source 226 and the X-ray detector 222 around the object 228 along a substantially circular arc, to acquire a plurality of projection images of the object 228 at different angles (e.g., different views or projections) that are typically less than 360 degrees, but may comprise a full rotation in some circumstances.

In operation, the object 228 is positioned in the imaging system 220 for performing an imaging scan. For example, the X-ray source 226 may be positioned above, below or around the object 228. For example, the X-ray source 226 (and the X-ray detector(s) 222) may be moved between different positions around the object 228 using the gantry 234. X-rays are transmitted from the X-ray source 226 through the object 228 to the X-ray detector(s) 222, which detect X-rays impinging thereon.

The readout electronics 232 may include a reference and regulation board (RRB) or other data collection unit. The RRB may accommodate and connect data modules to transfer data (e.g., a plurality of views or projections) from the X-ray detector(s) 222 to the data acquisition system 230. Thus, the readout electronics 232 transmit the data from the X-ray detector(s) 222 to the data acquisition system 230. The data acquisition system 230 forms an image from the data and may store, display (e.g., on the display 233), and/or transmit the image. For example, the various embodiments may include an image reconstruction module 236, which may be implemented in hardware, software, or a combination thereof, that allows the data acquisition system to reconstruct images using X-ray data (e.g., radiographic or tomosynthesis data) acquired from the X-ray detector(s) 222 and as described in more detail herein.

### Computed Tomography Scanner Overview—Computing Device

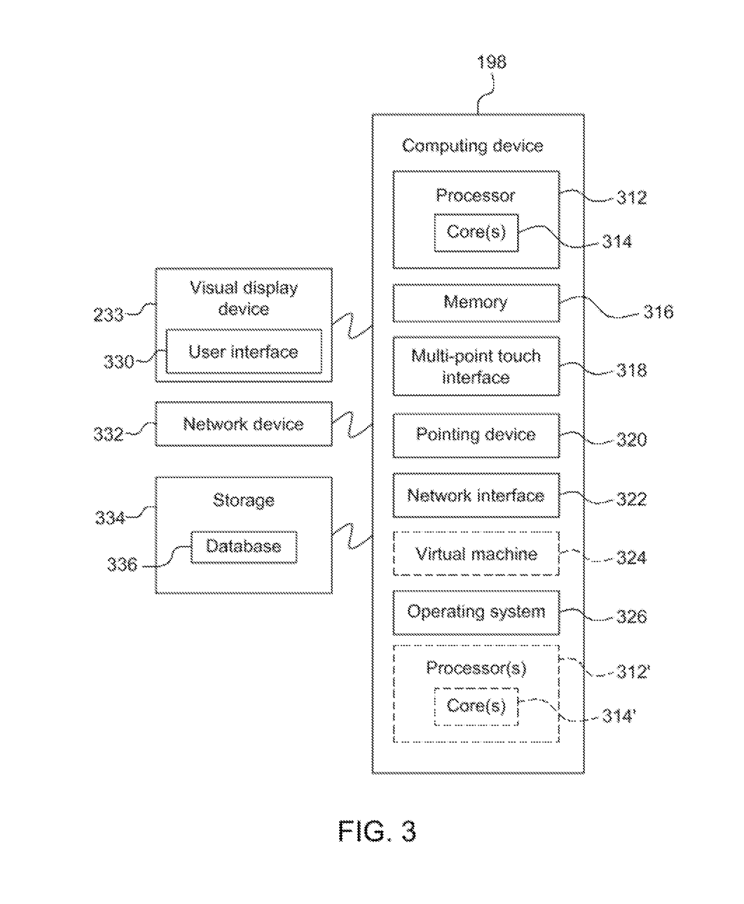

In some embodiments computer 198 may control the operation of the system 170 and may implement various aspects of the disclosed embodiments. FIG. 3 is a block diagram of an exemplary computing device 198 such as may be used in certain embodiments. The computing device 198 may include one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 316 included in the computing device 198 may store computer-readable and computer-executable instructions or software for interfacing with and/or controlling an operation of the scanner system 170. The computing device 198 may also include configurable and/or programmable processor 312 and associated core 314, and optionally, one or more additional configurable and/or programmable processing devices, e.g., processor(s) 312′ and associated core(s) 314′ (for example, in the case of computer systems having multiple processors/cores), for executing computer-readable and computer-executable instructions or software stored in the memory 316 and other programs for controlling system hardware. Processor 312 and processor(s) 312′ may each be a single core processor or multiple core (314 and 314′) processor.

Virtualization may be employed in the computing device 198 so that infrastructure and resources in the computing device may be shared dynamically. A virtual machine 324 may be provided to handle a process running on multiple processors so that the process appears to be using only one computing resource rather than multiple computing resources. Multiple virtual machines may also be used with one processor.

Memory 316 may include a computer system memory or random access memory, such as DRAM, SRAM, EDO RAM, and the like. Memory 316 may include other types of memory as well, or combinations thereof.

A user may interact with the computing device 198 through a visual display device 233, such as a computer monitor, which may display one or more user interfaces 330 that may be provided in accordance with exemplary embodiments. Visual display device 233 may be the same as display system 204 in some embodiments. The computing device 198 may include other I/O devices for receiving input from a user, for example, a keyboard or any suitable multi-point touch interface 318, a pointing device 320 (e.g., a mouse). The interface 318 such as a keyboard and the pointing device 320 may be coupled to the visual display device 233. The computing device 198 may include other suitable conventional I/O peripherals.

The computing device 198 may also include one or more storage devices 334, such as a hard-drive, CD-ROM, or other computer readable media, for storing data and computer-readable instructions and/or software that interface with and/or control an operation of the scanner system 170 described herein and/or to implement exemplary processes described herein. Exemplary storage device 334 may also store one or more databases for storing any suitable information required to implement exemplary embodiments. For example, exemplary storage device 334 can store one or more databases 336 for storing information, such as scan sequences, X-ray data, X-ray images, photon counts, estimation of electrical properties, electrical property maps, and/or any other information that can be used to implement exemplary embodiments of the present disclosure. The databases may be updated by manually or automatically at any suitable time to add, delete, and/or update one or more items in the databases.

The computing device 198 can include a network interface 322 configured to interface via one or more network devices 332 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 322 may include a built-in network adapter, network interface card, PCMCIA network card, card bus network adapter, wireless network adapter, USB network adapter, modem or any other device suitable for interfacing the computing device 198 to any type of network capable of communication and performing the operations described herein. Moreover, the computing device 198 may be any computer system, such as a workstation, desktop computer, server, laptop, handheld computer, tablet computer, or other form of computing or telecommunications device that is capable of communication and that has sufficient processor power and memory capacity to perform the operations described herein.

The computing device 198 may run any operating system 326, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 326 may be run in native mode or emulated mode. In an exemplary embodiment, the operating system 326 may be run on one or more cloud machine instances.

In exemplary embodiments, the CT system 170 can be configured and/or programmed to transmit instructions, commands, and/or requests to the computing device 198 to control the CT-scan components to perform scan sequences and can be programmed and/or configured to receive CT-scan data or CT-scan images from the computing device 198.

### Exemplary X-Ray Tube

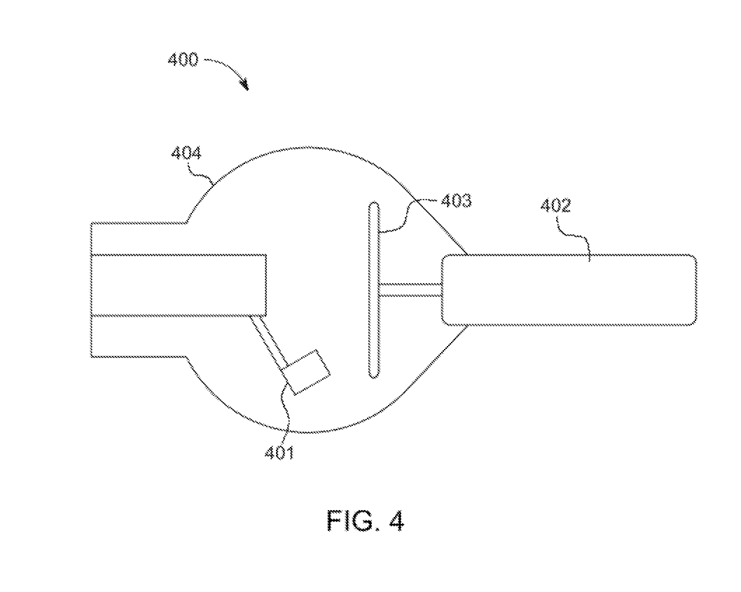

FIG. 4 is an exemplary figure of a rotating anode X-ray tube as may be used in certain embodiments. The tube 400 may be a part of X-ray source 174 used in the system 170, although one will readily recognize numerous alternative X-ray tubes that may be used in system 100 and numerous alternative applications to which X-ray tubes may be applied than the CT-scanning of system 170 (baggage scanning, crystallography, etc.). Tube 400 includes a glass window 404, a cathode 401, and a target anode 403. In some tubes the anode 403 may be fixed, but in this example the anode 403 is attached to a rotating series of bearings 402. The anode may be rotated during operation to more evenly distribute the use of the anode surface area. The anode 403 may comprise, for example, tungsten, molybdenum or copper.

During operation, cathode 401 will emit electrons which impact anode 403. X-rays may be emitted in a path perpendicular to this electron beam. Over time, electron impacts will roughen the surface of anode 403 and gradually eject anode material along the inner surface of glass window 404. In addition, the filament material may gradually deposit on the inner surface of the glass window as well. These changes may generally degrade the quality of the emitted X-rays and are generally referred to herein as “target filtration” or “filtration”. Eventually, filtration will so adversely affect the tube's operation that the tube will need to be replaced. Prior to its removal, the tube may operate in an unexpected manner, as the degree of “target filtration” and its effect on the X-rays may not be precisely known. Applying the same current and voltage to the tube at the beginning of its lifecycle may not produce the same character of X-rays as the tube approaches the end of its life cycle. Many spectral calibration methods and dual energy material decomposition methods require good knowledge and/or modeling of the emitted X-ray spectra. In applications such as CT imaging, it is very important to compensate for the tube aging effect so as to achieve high quality CT images.

### Effect of Target Filtration on X-Ray Emissions

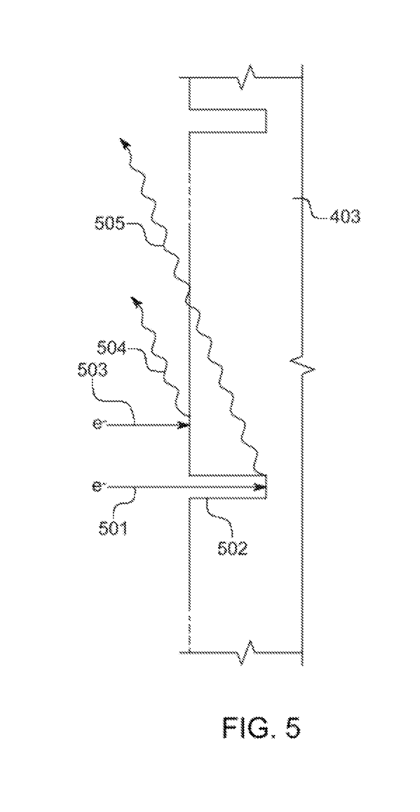

FIG. 5 is a cross-sectional view of the surface of an anode target, depicting the effect of roughening at the anode. As cracks 502 form in the anode 403 the path taken by a first electron 501 differs from the path taken by a second electron 503. A direct ray 504 emitted because of electron 503 will not be filtered by the anode material 403. However, the ray 505 generated by electron 501 will be affected by the material 403 which falls in its path. Thus, the surface of the anode may contribute to target filtration. In conjunction with emitted anode particles coating the inside of the glass 404, these two phenomena may significantly affect the output of the tube.

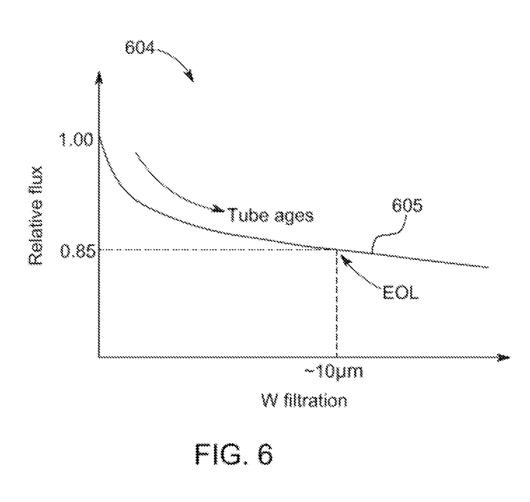

FIG. 6 depicts changes in the relative photon flux at an X-ray detector, such as detector array 178, outside the tube as filtration increases. Here, the relative flux is the ratio of the present flux to the flux at the tube's first time of use. As the tube ages the present day flux relative to the original flux will decrease as filtration increases, as indicated by the curve 605. Eventually, the tube will reach the end of its operational life. In this example, this may occur when the relative flux reaches a value of approximately 0.85. Inferring the relative flux from the behavior of the X-ray tube would accordingly indicate the remaining lifetime of the X-ray tube. In some embodiments, the curve 605 may be measured or simulated when the tube is new. In some embodiments, a 15% drop in photon flux may be considered an end of life (EOL) point and the corresponding tungsten filtration (˜10 um) can be used as an upper limit.

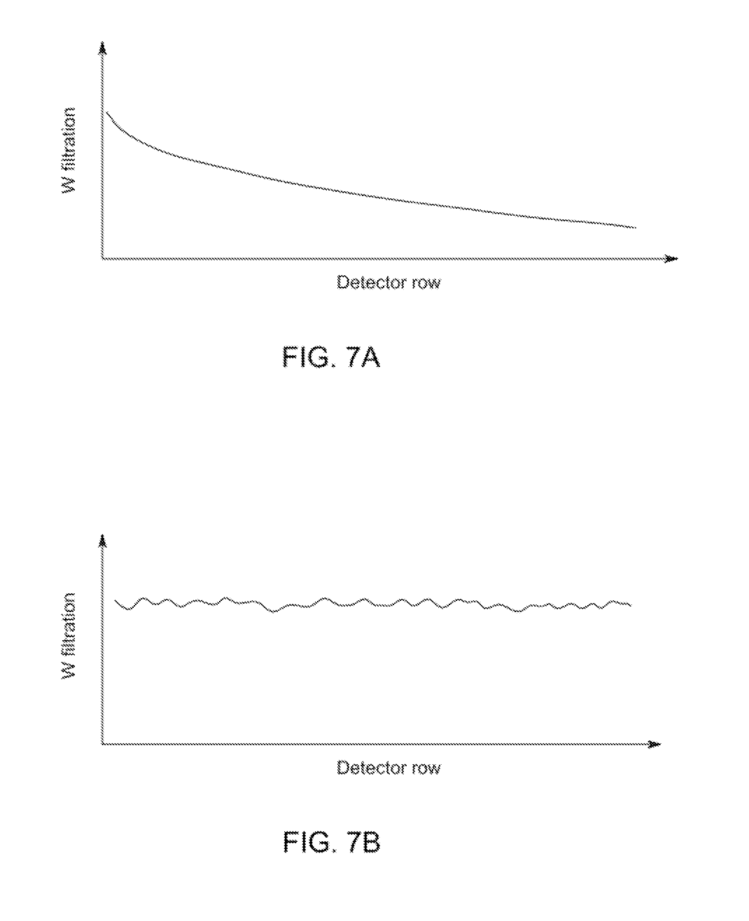

FIGS. 7A and 7B indicate filtration's effect on different rows of a detector, such as detector array 178. Each row may possess different lines of sight to the X-ray tube. Accordingly, different rows will experience different degrees of filtration. FIG. 7A is a plot of the effect of target filtration per row as a consequence of a roughened anode surface (such as the varying anode 403 height depicted in FIG. 5). FIG. 7B is a plot of the effect of target filtration as a consequence per row of window deposition. As indicated, window deposition has a roughly consistent effect for each row, while certain rows are more affected by a roughened anode surface than others as a consequence of their respective lines of sight to the X-ray tube. These different behaviors at the detector may be used to distinguish the effects of target roughness and window deposition and to better model and compensate for X-ray tube aging.

### Overview of Methods for Determining a Degree of Target Filtration

As illustrated in FIG. 6, if the generator 190 and the detector array 178 operate in a relatively stable manner over the life of the CT system, the change in photon flux over time may be used to estimate the degree of filtration. Once the filtration degree is known, offsets and other compensation methods may be applied to, e.g., each of high voltage generator 190 and the detector array 178 to compensate for the aging. The curve 605 may also be inferred via simulation or by real-world determination.

Accordingly, certain embodiments contemplate monitoring the flux over time, such as with a software hook on the CT scanner 170 which is activated on the scanner's first use each day. The degree of filtration may then be determined by comparing the measured photon flux change with the established mapping function 605. Once the filtration is known, the spectral calibration/dual-energy material decomposition model may be improved by taking the extra filtration into account to compensate for the effects of tube aging.

In some embodiments, simply taking the ratio of the present day flux to the flux at first use may not be sufficiently accurate to determine the filtration degree. Accordingly, various embodiments contemplate applying one or more of the following methods for using the flux to assess a filtration degree: “Absolute Flux Change”, “Row-to-Row Change”, “Flux Ratio”, and “Spectral Transmission”. These approaches may be used individually or in combination to complement one another's benefits, as described in greater detail below.

### “Absolute Flux Change” Method for Determining a Degree of Target Filtration

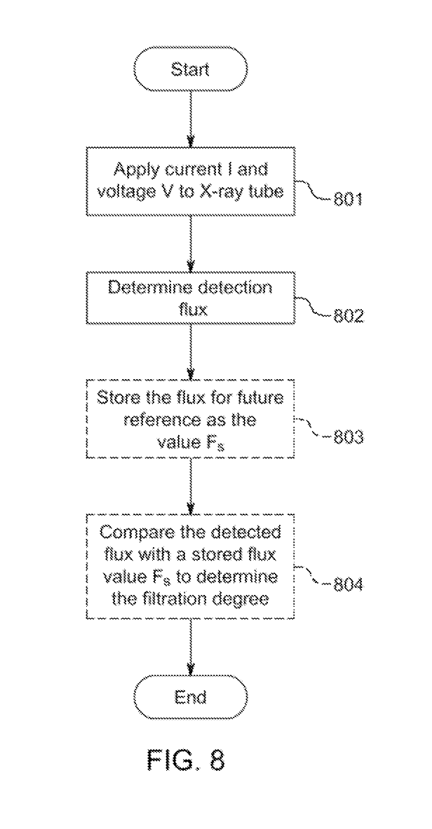

FIG. 8 is a flow chart depicting aspects of an “Absolute Flux Change” method for determining a degree of target filtration. The method may begin at block 801 by applying a current I and voltage V to the X-ray tube. This will cause the tube to emit a plurality of X-ray photons which may be measured at a particular flux F at block 802 by the detector. Flux F may be the flux at a single row or detection cell of the detector, or an average over a plurality of rows or detection cells.

If the method is applied to generate a reference value, such as on the first day of use, the system may then store the flux F for future reference at block 803 as reference value Fₛ. If the method is instead being used to determine the degree of filtration, the system may compare the flux F with a stored value Fₛ at block 804.

The system may periodically apply the method, activating block 804 rather than 803, upon subsequent usage events, to assess the degree of target filtration by comparing F and Fₛ with a mapping 605, such as is depicted in FIG. 6. The mapping may relate a relation value between F and Fₛ, such as a ratio, to a degree of target filtration or a tube age. The system may then compensate for the determined degree of target filtration degree when interpreting the X-ray photons detected at the detector 178.

### “Row-to-Row Change” Method for Determining a Degree of Target Filtration

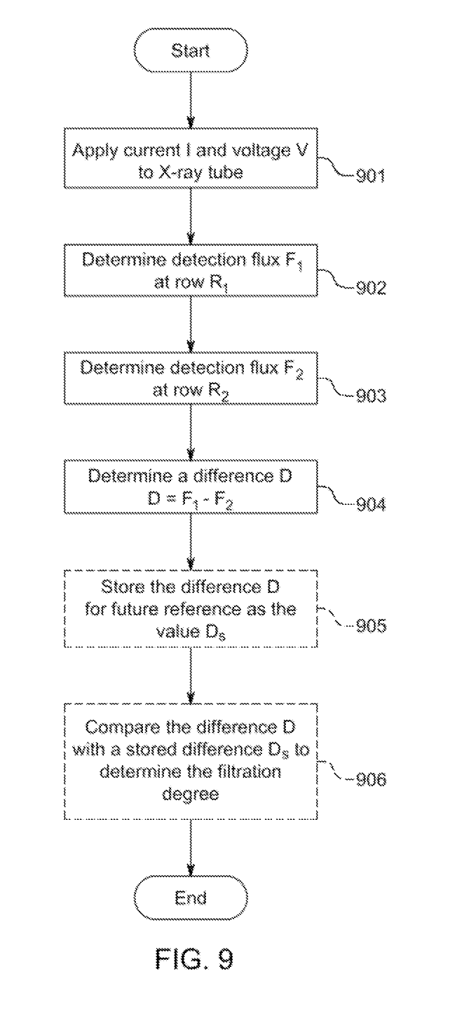

FIG. 9 is a flow chart depicting aspects of a “Row-to-Row Change” method for determining a degree of target filtration. The method may begin at block 901 by applying a current I and voltage V to the X-ray tube. This will cause the tube to emit a plurality of X-ray photons. At block 902, the system may determine the flux F₁ at which these photons are received at a first row of the detector 178. At block 902, the system may determine the flux F₂ at which these photons are received at a second row of the detector 178. In some embodiments, fluxes F₁ and F₂ may be averaged across the detection cells in each respective row. In other embodiments, one may use collections of contiguous detection cells as a “row” rather than a linear array of detection cells from a Cartesian grid. For example, the detector array may comprise detection cells in expanding concentric circles. A “row” in this example may include each of the detection cells in one of the circles.

At block 904 the system may then determine a relation value, such as a difference value D between F₁ and F₂. Though illustrated here as a subtraction, one will readily recognize a plurality of ways for assessing the difference, such as by taking the ratio of F₁ and F₂, mapping the fluxes to a different measurement space, etc. For example, in some embodiments offset corrections and normalizations, such as by logarithms, may be applied to each flux value prior to their subtraction, division, or other relation. In any event, the representative difference value D may then be used to determine the degree of target filtration.

Particularly, where the method is applied to generate a reference value, such as on the first day of use, the system may store the difference D for future reference at block 905 as the stored value Dₛ. If the method is instead being used to determine the degree of filtration, the system may compare the difference D with a stored value Dₛ at block 906.

The system may periodically apply the method, activating block 906 rather than 905, upon subsequent usage events, to assess the degree of target filtration by comparing the relation between D and Dₛ with a mapping, analogous to mapping 605, as depicted in FIG. 6. While mapping 605 concerns the ratio between two fluxes, the mapping in the “Row-to-Row” change method may relate the two differences D and Dₛ to the target filtration degree. The system may then compensate for the determined target filtration degree when interpreting the X-ray photons detected at the detector 178.

In some embodiments, after performing step 904 the system may then perform steps 901 through 904 a second time to acquire a second difference D₂. During this second iteration a different voltage V and current I may be applied at block 901 than were applied in the first iteration. In these embodiments, the system may then store a relationship between D and D₂, such as their difference or ratio, as the stored value Dₛ. The system may then compare the result of subsequent runs to the value Dₛ to determine the degree of target filtration. Depending on the voltage and current values pertinent to a particular X-ray tube, the system may perform not only two, but three, four, or N iterations in this manner for each different voltage and/or current values.

### “Flux Ratio” Method for Determining a Degree of Target Filtration

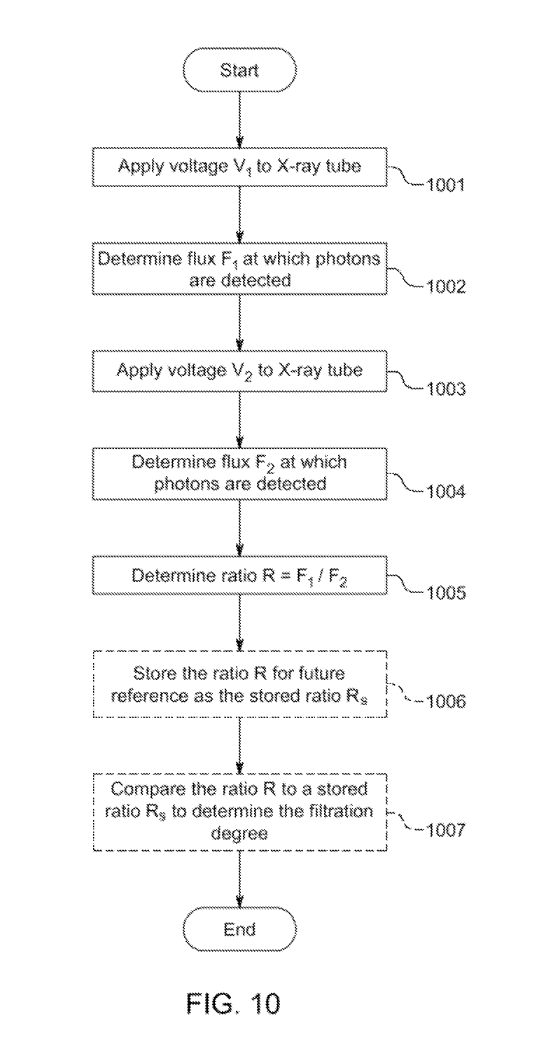

FIG. 10 is a flow chart depicting aspects of a “Flux Ratio” method for determining a degree of target filtration. The method may begin at block 1001 by applying a voltage V₁ to the X-ray tube. This will cause the tube to emit a plurality of X-ray photons. At block 1002, the system may determine the flux F₁ at which these photons are received at the detector. Flux F₁ may be the flux at a single row or detection cell of the detector, or an average over a plurality of rows or detection cells. At block 1003, the system may apply a second voltage V₂ to the X-ray tube. Second voltage V₂ may be greater or less than first voltage V₁. Because V₂ is different from V₁, the corresponding photons emitted from the tube will have a different mean frequency value. The system may then determine the flux F₂ at which these photons are received at the detector at block 1004. Flux F₂ may similarly be the flux at a single row or a single detection cell of the detector 178, or an average over a plurality of rows or detection cells.

At block 1005 the system may then determine a relation value, such as a ratio R between F₁ and F₂. Though illustrated here as F₁/F₂, one will readily recognize a plurality of ways for assessing the ratio, such as by instead taking F₂/F₁, etc. Similarly, offset corrections and normalizations, such as by logarithms, may be applied prior to determining a relationship between F₁ and F₂. In any event, the representative ratio value R may then be used to determine the degree of target filtration. Furthermore, as discussed above with respect to the “row-to-row” change embodiments, in certain embodiments of the “Flux Ratio” embodiments, the system may adjust both the voltage and currents at steps 1001 and 1003. When the currents and voltages are known at each step the system may normalize the corresponding measurement.

If the method is applied to generate a reference value, such as on the first day of use, the system may store the ratio R for future reference at block 1006 as stored ratio Rₛ. If the method is instead being used to determine the degree of filtration, the system may compare R with the stored ratio Rₛ at block 1007.

The system may periodically apply the method, activating block 1007 rather than 1006, upon subsequent usage events, to assess the degree of target filtration by comparing the relation between R and Rₛ with a mapping similar to the mapping 605 of FIG. 6. While mapping 605 concerns the ratio between two fluxes, the mapping in the “Flux Ratio” method may relate the two relation values R and Rₛ to the target filtration degree. The system may then compensate for the target filtration degree when interpreting the X-ray photons detected at the detector.

### “Spectral Transmission” Method for Determining a Degree of Target Filtration

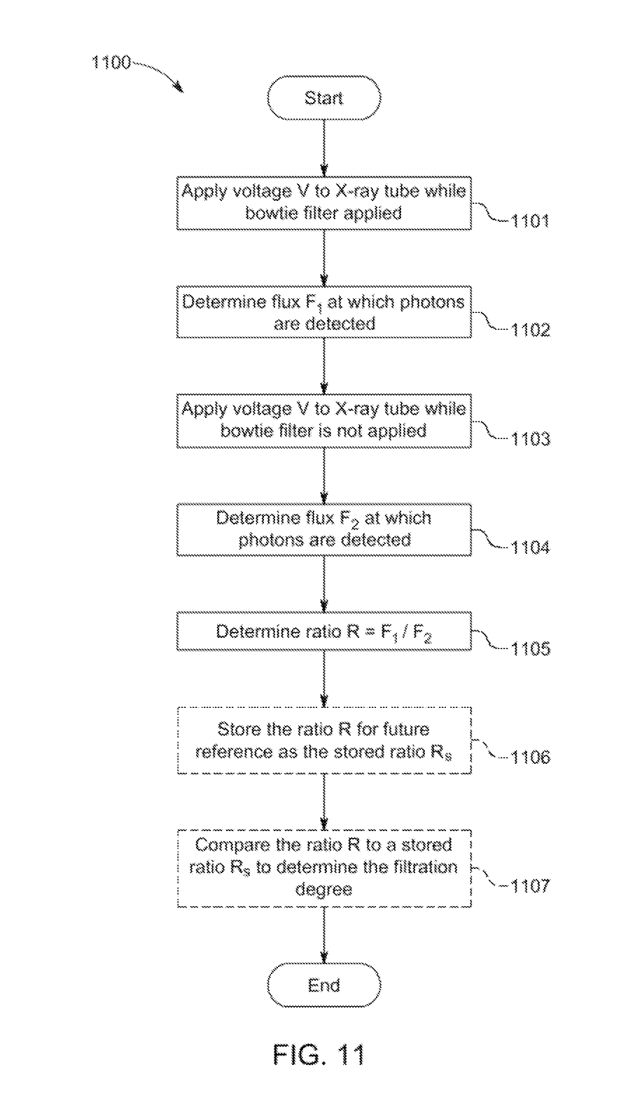

FIG. 11 is a flow chart depicting aspects of a “Spectral Transmission Change” method for determining a degree of target filtration. Although the examples provided herein discuss a “bowtie filter” various filters may be applied to the X-ray emission source. For example, any spectral filter (such as a flat filter) may also be used. The bow-tie filter may attenuate the photon emissions along certain directions. The method 1100 may begin at block 1101 by applying a voltage V to the X-ray tube while the bowtie filter is applied. This will cause the tube to emit a plurality of X-ray photons subject to the attenuation caused by the bow-tie filter. At block 1102, the system may determine the flux F₁ at which these photons are received at the detector. Flux F₁ may be the flux at a single row or detection cell of the detector, or an average over a plurality of rows or detection cells.

At block 1103, the system may apply the same voltage V to the X-ray tube, but without the attachment of a bowtie filter. Because the bowtie filter is removed, the emitted photons will not be attenuated. The system may then determine the flux F₂ at which these photons are received at the detector at block 1104. Flux F₂ may similarly be the flux at a single row or detection cell of the detector, or an average over a plurality of rows or detection cells.

At block 1105 the system may then determine a relation value, such as a ratio R between F₁ and F₂. Though illustrated here as F₁/F₂, one will readily recognize a plurality of ways for assessing the ratio, such as by instead taking F₂/F₁, etc. Furthermore, in some variations a different or other relation between the values may be determined. In any event, the representative ratio value R may then be used to determine the degree of target filtration. In some embodiments, rather than removing the filter at block 1103 the filter may be replaced with a filter having a different thickness. In some embodiments, only one filter is used with a varying thickness and the blocks 1101-1104 may be combined into a single step. In these embodiments, different portions of the detector corresponding to photons passing through the different filter thicknesses will measure the fluxes F₁ and F₂.

If the method is applied to generate a reference value the system may store the ratio R for future reference at block 1106 as stored ratio Rₛ. If the method is instead being used to determine the degree of filtration, the system may compare R with the stored ratio Rₛ at block 1107.

In some embodiments, the system may perform the method 1100, storing the difference value R as stored difference value Rₛ upon the first use of the tube. The system may then periodically apply the method, activating block 1107 rather than 1106, upon subsequent usage events, to assess the degree of target filtration by comparing the relation between R and Rₛ with a mapping similar to the mapping 605 of FIG. 6. While mapping 605 concerns the ratio between two fluxes, the mapping in the “Spectral Transmission” method may relate the two ratios R and Rₛ to the target filtration degree. The system may then compensate for the target filtration degree when interpreting the X-ray photons detected at the detector.

Though each of the example embodiments discussed above in relation to the four methods references a previously stored value (e.g., Fₛ at block 804, Rₛ at block 1007, etc.), certain embodiments contemplate averaging the stored value over time or otherwise updating the stored value to reflect non-ideal behaviors in the X-ray system. Target filtration may occur over a long period of time and certain embodiments adjust the reference value, such as by averages, to account for brief anomalous behavior or measurement noise.

Although certain of the above examples suggest storing only a single value stored value (e.g., Fₛ at block 804, Rₛ at block 1007, etc.), in some embodiments, there may be more than one value being stored. For example, there may be one value that relates to the X-ray tube in its original state (such as when it was new), and another value that relates to the X-ray tube in its current state (such as with the added tungsten filtration). Furthermore, as tungsten filtration build-up is typically a slow process, the individually measured values may then slowly update the value that relates to the X-ray tube in its current state. When the determination of the filtration degree then at least partly uses the at least two stored values, the negative effects of measurement noise can be reduced.

### Comparison and Combination of Determination Methods

Each of the methods described above provides unique coverage of the flux change resulting from filtration. Consequently, certain embodiments contemplate using combinations of the methods so as to take advantage of their complementary abilities to measure filtration. Current and voltage drift may refer to the inaccurate generation of current and voltage values over time. That is, as the system ages it may be less likely to output as accurate a current or voltage as requested at the input.

TABLE I
A SUMMARY OF THE FOUR APPROACHES'
COMPLEMENTARY CHARACTER

| Approach | | Pros | Cons |
|---|---|---|---|
| a) | Abso- | Large magnitude of | The method may be |
| | lute | the change permits | sensitive to current |
| | Flux | more granular determi- | and voltage drifts |
| | Change | nation of filtration | |
| b) | Row-to- | As indicated in | The method may not |
| | Row | FIGs. 6A-B, comparing | be able to capture a |
| | Change | detector rows may permit | global change on |
| | | distinguishing target | the whole detector |
| | | surface roughness from | |
| | | target material on the | |
| | | tube window | |
| | | The method may be further | |
| | | generally immune to | |
| | | current and voltage drift | |
| c) | Flux | Moderate magnitude of the | The method may be |
| | Ratio | change permits more granular | sensitive to |
| | | determination of filtration | voltage drift |
| | | The method may be further | |
| | | generally immune to current | |
| | | drift | |
| d) | Spec- | The method may be capable | The method may require |
| | tral | of capturing beam harden- | more flux data to capture |
| | Trans- | ing of the extra anode | operation both with and |
| | mission | material very well | without the spectral filter |
| | | The method may be | The method may also |
| | | generally immune to current | require good knowledge of |
| | | and voltage drift | the spectral filter's |
| | | | behavior |

Accordingly, certain embodiments contemplate systems which apply various combinations of each of the four methods. For example, a system may initially apply the “Absolute Flux” method early in the tube's lifecycle. As the system ages and voltage and current drift become more prevalent, the system may gradually rely more heavily upon the “Row to Row” change. The methods may also be applied simultaneously throughout the tube's lifecycle to complement one another's benefits as part of the assessment.

### Remarks

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A method for estimating anode filtration in an X-ray tube, comprising:
applying a current and a voltage to the X-ray tube;
emitting a plurality of photons from the X-ray tube;
determining a first flux at which at least some of the plurality of photons are detected at a detector;
comparing the first flux with a second stored flux value, the second stored flux value based on a previous application of the current and the voltage to the X-ray tube; and
determining a degree of anode filtration based on the comparison of the first flux with the second stored flux value.

2. The method of claim 1, wherein the previous application of the current and the voltage to the X-ray tube occurred upon the first activation of the X-ray tube.

3. The method of claim 1, wherein the anode filtration comprises tungsten.

4. The method of claim 1, further comprising estimating the life of the X-ray tube based upon the degree of anode filtration.

5. The method of claim 1, wherein determining a degree of anode filtration comprises supplying the comparison to a function mapping the comparison to a degree of anode filtration.

6. A method for estimating anode filtration in an X-ray tube, comprising:
applying a current and a voltage to the X-ray tube;
emitting a plurality of photons from the X-ray tube;
determining a first flux at which at least some of the plurality of photons are detected at a first row of a detector;
determining a second flux at which at least some of the plurality of photons are detected at a second row of the detector;
determining a relative change value between the first and second flux;
comparing the relative change value with a stored relative change value, the stored relative change value based on a previous application of substantially the same current and substantially the same voltage to the X-ray tube; and
determining a degree of anode filtration based on the comparison of the relative change value and the stored relative change value.

7. The method of claim 6, wherein the previous application of the current and the voltage to the X-ray tube occurred upon the first activation of the X-ray tube.

8. The method of claim 6, wherein the anode filtration comprises tungsten.

9. The method of claim 6, further comprising estimating the remaining life of the X-ray tube based upon the degree of anode filtration.

10. The method of claim 6, wherein determining a degree of anode filtration comprises supplying the comparison to a function mapping the comparison to a degree of anode filtration.

11. A method for estimating anode filtration in an X-ray tube, comprising:
applying a first voltage to the X-ray tube;
emitting a first plurality of photons from the X-ray tube;
determining a first flux at which at least some of the first plurality of photons are detected at a detector;
applying a second voltage to the X-ray tube;
emitting a second plurality of photons from the X-ray tube;
determining a second flux at which at least some of the second plurality of photons are detected at a detector;
determining a first relation value between the first and second flux;
comparing the first relation value with a second stored relation value, the second stored relation value based on a previous application of substantially the same first voltage and substantially the same second voltage to the X-ray tube; and
determining a degree of anode filtration based on the comparison of the first relation value and the second stored relation value.

12. The method of claim 11, wherein the first relation value is a ratio of the first flux and the second flux and the stored relation value is a ratio of a first flux and a second flux.

13. The method of claim 11, wherein the previous application of substantially the same first voltage and substantially the same second voltage to the X-ray tube occurred upon the first activation of the X-ray tube.

14. The method of claim 11, wherein the X-ray tube comprises tungsten deposition on an X-ray window.

15. The method of claim 11, further comprising estimating the remaining life of the X-ray tube based upon the degree of anode filtration.

16. The method of claim 11, wherein determining a degree of anode filtration comprises supplying the comparison to a function mapping the comparison to a degree of anode filtration.

17. A method for estimating anode filtration in an X-ray tube, comprising:
applying a first amount of spectral filtering to at least a portion of the X-ray tube using a spectral filter;
emitting a first plurality of photons from the X-ray tube with the first amount of spectral filtering;
determining a first flux at which at least some of the first plurality of photons are detected at a detector;
emitting a second plurality of photons from the X-ray tube with a second amount of spectral filtering, the second amount of spectral filtering different from the first amount of spectral filtering;
determining a second flux at which at least some of the second plurality of photons are detected at a detector;
determining a first relation value between the first and second flux;
comparing the first relation value with a second stored relation value, the second stored relation value based on a previous photon emission from the X-ray tube applying the first amount of spectral filtering and a photon emission from the X-ray tube applying the second amount of spectral filtering; and
determining a degree of anode filtration based on the comparison of the first relation value and the second stored relation value.

18. The method of claim 17, wherein the first relation value is a ratio of the first flux and the second flux and the stored relation value is a ratio of a first flux and a second flux.

19. The method of claim 17, wherein the previous photon emission from the X-ray tube applying the first amount of spectral filtering and the previous photon emission from the X-ray tube applying the second amount of spectral filtering occurred upon the first activation of the X-ray tube.

20. The method of claim 17, wherein the anode filtration comprises tungsten.

21. The method of claim 17, further comprising estimating the life of the X-ray tube based upon the degree of anode filtration.

22. The method of claim 17, wherein determining a degree of anode filtration comprises supplying the comparison to a function mapping the comparison to a degree of anode filtration.
